(19) United States
(12) Patent Application Publication
(10) Pub. No.: US 2009/0239501 A1
(43) Pub. Date: Sep. 24, 2009

(54) COMMUNICATION APPARATUS AND COMPUTER PRODUCT

(75) Inventors: Kazuki MATSUI, Kawasaki (JP); Masahiko MURAKAMI, Kawasaki (JP); Masahide NODA, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/401,845

(22) Filed: Mar. 11, 2009

(30) Foreign Application Priority Data
Mar. 21, 2008 (JP) 2008-074319

(51) Int. Cl. H04M 3/16

(52) U.S. Cl. 455/410

(57) ABSTRACT

A communication apparatus includes an executor configured to execute given process, a restrictor configured to restrict the executor from executing the given process, an authenticator configured to perform authentication, a canceller configured to cancel the restriction applied by the restrictor if the authentication by the authenticator has succeeded, a communicator capable of wirelessly communicating with a wireless station, and a time measurer configured to measure time that has elapsed since wireless communication with the wireless station became difficult. If a previously set restriction condition that a state where the wireless communication with the wireless station is difficult continues until the time measured by the time measurer reaches a given value is satisfied, the restrictor restricts execution of the given process.

### CROSS-REFERENCE TO RELATED APPLICATIONS

This application is based upon and claims the benefit of priority of the prior Japanese Patent Application No. 2008-74319, filed on Mar. 21, 2008, the entire contents of which are incorporated herein by reference.

### BACKGROUND

1. Field

The embodiment discussed herein is related to a communication apparatus capable of wireless communication with a wireless station.

2. Description of the Related Art

Function-enhanced mobile phones equipped with a wireless LAN communication function have also been proposed in addition to mobile phone networks.

Opportunities to utilize communication apparatuses, such as mobile phones, in business of companies are increasing with changes in the communication environment, such as function enhancement of mobile phones, an open OS platform, and broadband mobile communication.

In addition to business, an opportunity to process confidential information, such as private information, with mobile phones is also increasing.

In this manner, with function enhancement of mobile phones, an opportunity to handle important confidential information, regardless of whether the information is private information or public information, is increasing.

An increase in importance of communication apparatuses, such as mobile phones, in response to function enhancement thereof also increases a risk for invalid use of the communication apparatuses by a third party due to loss or robbery of the communication apparatus.

Accordingly, the importance of authentication processing before use of communication apparatuses is increasing. Various authentication methods have been put into practical use, such as authentication of valid users through authentication of fingerprints of users.

For example, a method has been proposed for intermittently requesting authentication in order to prevent an invalid user from invalidly using a mobile phone after a valid user performs authentication to make the mobile phone usable.

A specific example is a method for restricting execution of a given process by activating a screen saver upon an operation-free period reaching a given value and requesting authentication for canceling the restriction.

It is said that the method effectively prevents invalid use of communication apparatuses, which have been misplaced, for example.

### SUMMARY

According to an aspect of the invention, a communication apparatus includes an executor configured to execute a given process, a restrictor configured to restrict the executor from executing the given process, an authenticator configured to perform authentication, a canceller configured to cancel the restriction applied by the restrictor if the authentication by the authenticator has succeeded, a communicator capable of wirelessly communicating with a wireless station, and a time measurer configured to measure time that has elapsed since wireless communication with the wireless station became difficult. If a previously set restriction condition that a state where the wireless communication with the wireless station is difficult continues until the time measured by the time measurer reaches a given value is satisfied, the restrictor restricts execution of the given process.

The above-described embodiments of the present invention are intended as examples, and all embodiments of the present invention are not limited to including the features described above.

### BRIEF DESCRIPTION OF THE DRAWINGS

FIG. 1 is an explanatory diagram showing an overview of a communication system including a communication apparatus according to the present invention;

FIG. 2 is a block diagram showing an example of a hardware configuration of a wireless mobile station according to an embodiment 1 of the present invention;

FIG. 3 is a functional block diagram showing an example of a functional configuration of a wireless mobile station according to an embodiment 1 of the present invention;

FIG. 4 is a functional block diagram showing examples of functional configurations of a wireless fixed station and an authentication apparatus according to an embodiment 1 of the present invention;

FIG. 5 is a flowchart showing an example of a process performed by a wireless mobile station according to an embodiment 1 of the present invention;

FIG. 6 is a flowchart showing an example of a process performed by a wireless mobile station and a wireless fixed station according to an embodiment 1 of the present invention;

FIG. 7 is a functional block diagram showing an example of a functional configuration of a wireless mobile station according to an embodiment 2 of the present invention;

FIG. 8 is a block diagram showing an example of a hardware configuration of an authentication apparatus according to an embodiment 2 of the present invention;

FIG. 9 is a functional block diagram showing an example of a functional configuration of an authentication apparatus according to an embodiment 2 of the present invention;

FIG. 10 is a flowchart showing an example of a process performed by a wireless mobile station according to an embodiment 2 of the present invention; and

FIG. 11 is a flowchart showing an example of a process performed by an authentication apparatus according to an embodiment 2 of the present invention.

### DETAILED DESCRIPTION OF THE PREFERRED EMBODIMENTS

Reference may now be made in detail to embodiments of the present invention, examples of which are illustrated in the accompanying drawings, wherein like reference numerals refer to like elements throughout.

Requesting authentication intermittently in methods according to the related art decreases convenience. For example, since authentication is requested when an in-coming telephone call is received by a communication apparatus, such as a mobile phone, used in a company, the call may be answered immediately.

An embodiment discussed herein provides a communication apparatus that improves convenience by restricting execution of a given process and requesting authentication after a given time has elapsed since wireless communication with a wireless station, such as a wireless LAN access point, became difficult.

Additionally, an embodiment discussed herein provides a communication apparatus for preventing convenience from decreasing by restricting execution of a given process and requesting authentication if the number of times that a handover process for changing a communication-partner wireless station has been performed reaches a given value.

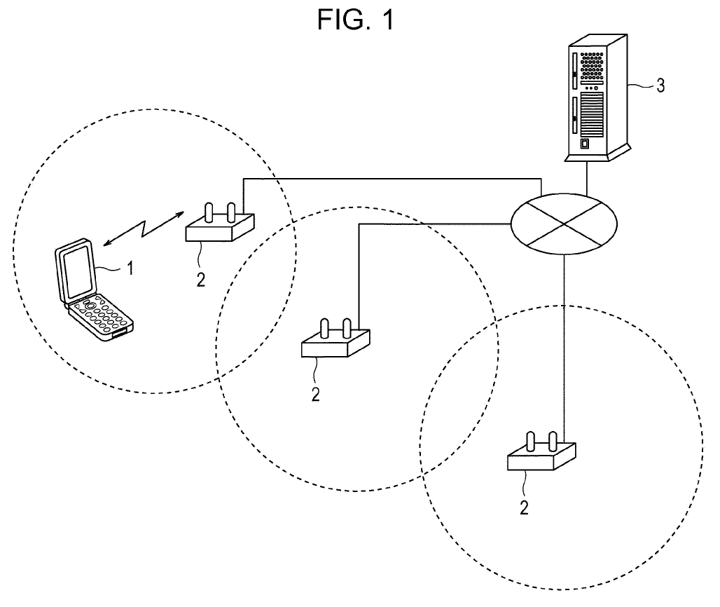

FIG. 1 illustrates an overview of a communication system including a communication apparatus according to an embodiment.

The communication system illustrated in FIG. 1 includes a wireless mobile station 1, such as a mobile phone, a plurality of wireless fixed stations 2, such as access points, and an authentication apparatus 3, such as a server computer for performing an authentication process regarding communication.

The wireless mobile station 1 includes a wireless LAN communication function. The wireless mobile station 1 may connect to a network, such as an in-house LAN, through one of the plurality of wireless fixed stations 2 serving as a communication-partner wireless LAN access point.

The authentication apparatus 3 performs authentication of the wireless mobile station 1 to be connected thereto through the wireless fixed station 2 to determine whether to permit connection from the wireless mobile station 1.

Apparatuses, such as mobile phones including various communication functions (e.g. a function of a wireless LAN terminal, a telephone function for connecting to a mobile phone network, and a function for connecting to a public network, such as the Internet), may be used as the wireless mobile station 1.

A communication apparatus according to an embodiment may be employed as the wireless mobile station 1, the wireless fixed stations 2, and the authentication apparatus 3 of the communication system illustrated in FIG. 1.

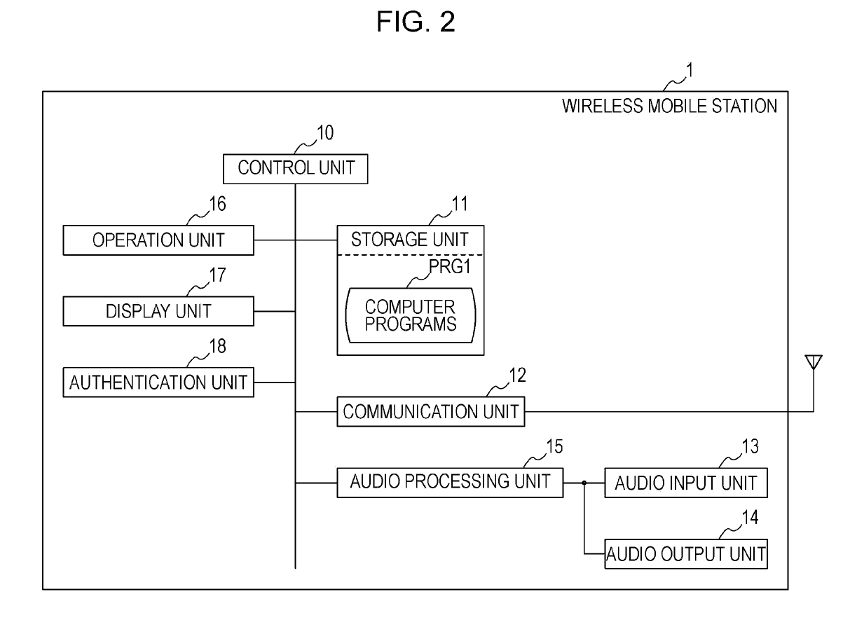

FIG. 2 illustrates an example of a hardware configuration of the wireless mobile station 1 according to an embodiment of the present invention.

The wireless mobile station 1 includes a controller 10, a storage 11, a communicator 12, an audio input 13, an audio output 14, an audio processor 15, an operator 16, a display 17, and an authenticator 18.

The controller 10 includes a circuit, such as a central processing unit (CPU) for controlling the apparatus, for example.

The storage 11 includes a memory, such as, for example, a read-only memory (ROM) or a random access memory (RAM). The storage 11 stores various control programs, such as a computer program PRG1 according to an embodiment of the present invention, and various kinds of data.

The controller 10 executes the computer program PRG1 according to an embodiment of the present invention stored in the storage 11. The wireless mobile station 1 functions as the communication apparatus according to an embodiment of the present invention.

The communication apparatus according to the embodiment of the present invention may be implemented as hardware including various circuits for realizing various functions to be described later.

The communicator 12 includes, for example, an antenna and an accompanying circuit thereof. The communicator 12 includes a function for connecting to a wireless LAN.

The communicator 12 may include a function for connecting to other networks, such as a mobile phone network.

The audio input 13 includes, for example, a microphone and an accompanying circuit thereof. The audio input 13 receives external sound, such as voice of a user, and converts the received sound into an audio signal.

The audio output 14 includes, for example, a speaker and an accompanying circuit thereof. The audio output 14 includes a function for outputting sound resulting from an audio signal.

The audio processor 15 includes, for example, an audio processing circuit. The audio processor 15 performs various kinds of processing on audio signals, such as an audio signal based on sound received by the audio input 13 and an audio signal resulting in sound to be output to the audio output 14.

The operator 16 includes, for example, various function key members, such as a numeral keypad, and an accompanying circuit thereof. The operator 16 includes a function for receiving user operations.

The display 17 includes, for example, a liquid crystal display and an accompanying circuit thereof. The display 17 displays various kinds of information as images.

The authenticator 18 includes an interface for authentication processing, such as fingerprint authentication. The authenticator 18 may include an accompanying circuit of the interface thereof. The authenticator 18 compares information indicating features of fingerprints scanned from fingers of a user with previously registered authentication information, thereby performing an authentication process.

As the authentication process performed by the authenticator 18, for example, biometrics authentication based on biometrics information such as voice print authentication or iris authentication, and an authentication process based on stored passwords may be performed.

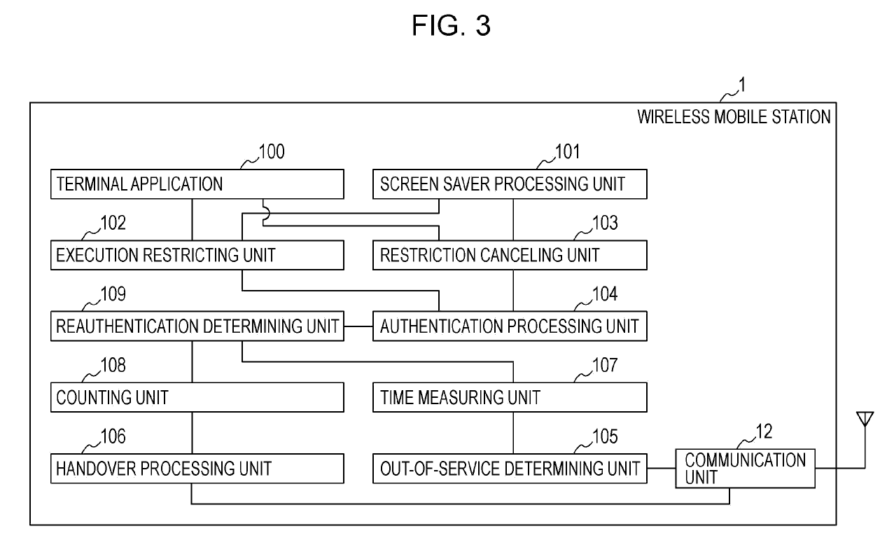

FIG. 3 illustrates an example of a functional configuration of the wireless mobile station 1 according to the embodiment of the present invention.

The controller 10 executes the computer program PRG1 stored in the storage 11, whereby the wireless mobile station 1 functions as a terminal application 100, a screen saver processor 101, an execution restrictor 102, a restriction canceller 103, an authentication processor 104, an out-of-service determiner 105, a handover processor 106, a time measurer 107, a counter 108, and a reauthentication determiner 109.

The terminal application 100 may include various control modules for executing a communication process, such as telephone communication and data communication, executed in the wireless mobile station 1.

In addition to the control modules for executing a communication process, control modules for executing various kinds of processing may be implemented as the terminal application 100.

For example, the terminal application 100 may execute processing regarding emails, such as assistance for creating an email, reception and transmission of an email, and browsing of an email, in cooperation with the terminal application 100 for executing communication processing.

The terminal application 100 may be a data acquiring and processing application for acquiring various kinds of information from the outside and processing the information. For example, the terminal application 100 may be an application for executing processing for realizing functions of a calculator or a digital camera.

As described above, the terminal application 100 may include control modules for executing various kinds of processing that is implementable in an apparatus, such as a mobile phone.

The screen saver processor 101 may be executed when execution of the terminal application 100 is restricted.

The execution restrictor 102 is a module that restricts services provided by the terminal application 100 and starts execution of the screen saver processor 101.

The restriction canceller 103 is a module that cancels restriction of services provided by the terminal application 100 and terminates execution of the screen saver processor 101.

The authentication processor 104 is a module that controls the authenticator 18 to request authentication processing and receive a result of the authentication processing. If the authentication has succeeded, the authentication processor 104 causes the restriction canceller 103 to cancel the restriction of execution of the terminal application 100 and to terminate execution of the screen saver processor 101.

The out-of-service determiner 105 is a module that detects intensity levels of radio waves transmitted from the wireless fixed stations 2 in cooperation with the communicator 12, compares the intensity levels of the radio waves transmitted from the wireless fixed stations 2 with each other, and determines whether a current location is an out-of-service area.

The handover processor 106 is a module that executes a handover process for changing a communication-partner (access-destination) wireless fixed station 2 in cooperation with the out-of-service determiner 105.

The time measurer 107 is a module that measures time that has elapsed since the out-of-service determiner 105 determined that wireless communication with the communication-partner wireless fixed station 2 or all of wireless fixed stations 2 became difficult (e.g. time that has elapsed since the out-of-service determiner 105 determined that an intensity of received signal from the wireless fixed stations 2 is less than given value).

The counter 108 is a module that counts the number of times that the communication-partner wireless fixed station 2 has been changed, namely, the number of times of handover processing.

The reauthentication determiner 109 is a module that determines whether a restriction condition is satisfied. The restriction condition may be whether the time measured by the time measurer 107 has reached a given value. The restriction condition may be whether the value counted by the counter 108 has reached a given value.

Upon determining that the restriction condition is satisfied, the reauthentication determiner 109 causes the execution restrictor 102 to restrict services of the terminal application 100 and to start execution of the screen saver processor 101 in order to request reauthentication.

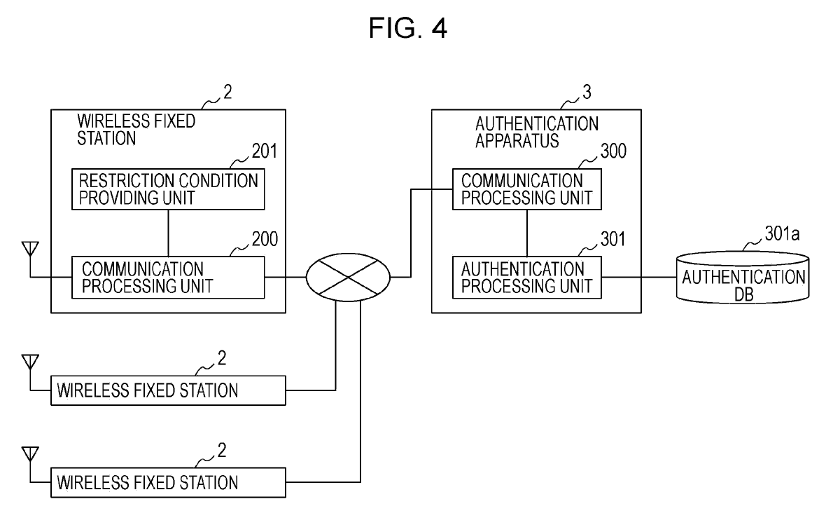

FIG. 4 illustrates examples of functional configurations of the wireless fixed station 2 and the authentication apparatus 3.

The wireless fixed station 2 includes a communication processor 200 and a restriction condition provider 201.

The communication processor 200 is a module that performs wireless communication with the wireless mobile station 1 and wireless or wired communication with the authentication apparatus 3 via an in-house LAN.

The restriction condition provider 201 is a module that provides restriction condition information indicating a restriction condition to the wireless mobile station 1.

The authentication apparatus 3 includes a communication processor 300 and an authentication processor 301.

The communication processor 300 is a module that communicates with other apparatuses via an in-house LAN.

The authentication processor 301 is a module that authenticates the wireless mobile station 1 with reference to an authentication database (authentication DB) 301a, which stores authentication information of the wireless mobile station 1.

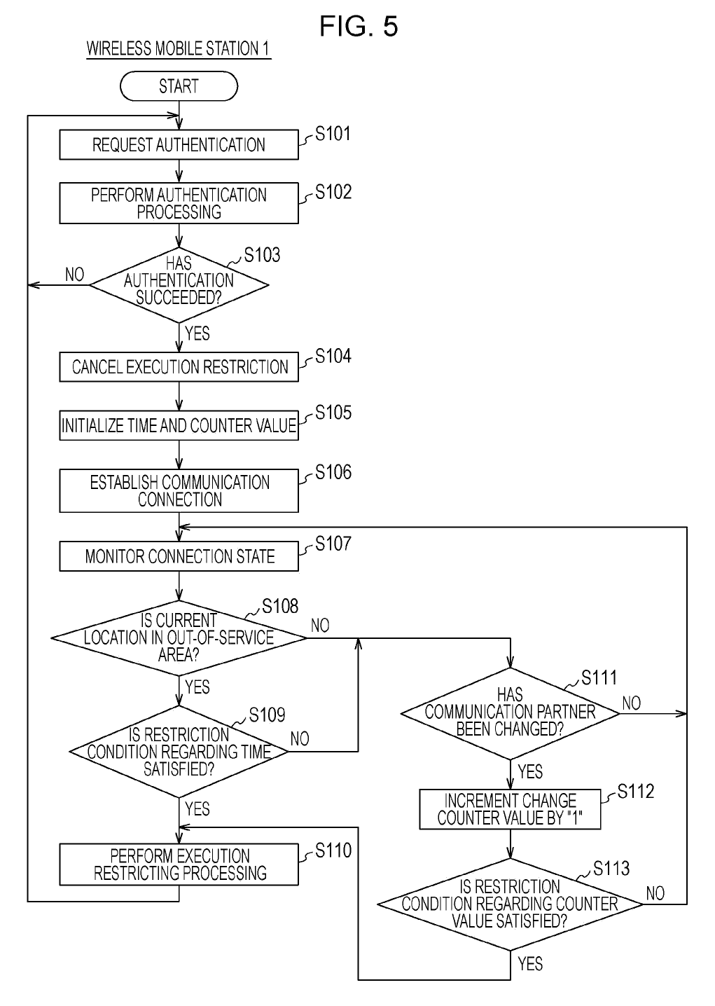

FIG. 5 illustrates an example of a process performed by the wireless mobile station 1.

After power-on, the wireless mobile station 1 requests authentication under control of the authentication processor 104 with execution of the terminal application 100 being restricted by the execution restrictor 102 (S101).

The authentication request (S101) is made by, for example, displaying a message for requesting authentication on the display 17.

After recognizing the authentication-requesting message, a user may touch the authenticator 18 with a finger, for example.

The authentication processor 104 compares information indicating features of fingerprints scanned by the authenticator 18 with given authentication information. In this manner, the wireless mobile station 1 executes an authentication process (S102).

In addition to the fingerprint authentication, for example, biometrics authentication based on biometrics information such as voice print authentication or iris authentication may be performed.

In addition, the information indicating the features of the fingerprints and identification information of the wireless mobile station 1 may be transmitted to the authentication apparatus 3. The authentication apparatus 3 may then compare the received information with the authentication information stored in the authentication DB 301a to perform authentication processing.

The authentication processor 104 of the wireless mobile station 1 determines whether the authentication has succeeded (S103).

If it is determined that the authentication has succeeded at OPERATION S103 (YES at S103), the restriction canceller 103 of the wireless mobile station 1 cancels restriction of services provided by the terminal application 100 (S104).

If the screen saver processor 101 is executing processing as a screen saver, execution of the screen saver processor 101 may be terminated.

In this way, the user is allowed to utilize a service provided by the terminal application 100.

If it is determined that the authentication has failed at OPERATION S103 (NO at S103), the process returns to OPERATION S101. The wireless mobile station 1 repeats operations starting from OPERATION S101.

After restriction of services provided by the terminal application 100 is cancelled at OPERATION S104, the wireless mobile station 1 initializes a time period measured by the time measurer 107 and a value counted by the counter 108 (S105). The communicator 12 establishes a connection to a wireless LAN (S106). The out-of-service determiner 105 and the handover processor 106 start monitoring the connection state (S107).

The out-of-service determiner 105 of the wireless mobile station 1 determines whether the wireless mobile station 1 is within an out-of-service area (S108).

If it is determined that the wireless mobile station 1 is within the out-of-service area of the wireless fixed station 2 and wireless communication with the wireless fixed station 2 is difficult at OPERATION S108 (YES at S108), the reauthentication determiner 109 of the wireless mobile station 1 determines whether the time period measured by the time measurer 107 since the wireless communication has become difficult satisfies a previously set restriction condition (S109).

More specifically, at OPERATION S109, the wireless mobile station 1 determines whether a restriction condition that wireless communication with the wireless fixed station 2 is continuously difficult until the time period measured by the time measurer 107 reaches the given value is satisfied.

If it is determined that the restriction condition regarding time is satisfied at OPERATION S109 (YES at S109), i.e., if it is determined that at least given time has passed since the communication became difficult, the wireless mobile station 1 performs an execution restricting process (S110). The process then returns to OPERATION S101. Operations starting from OPERATION S101 are repeated.

The execution restricting process performed at OPERATION S110 may be processing for causing the execution restrictor 102 to restrict execution of the terminal application 100 and to start execution of the screen saver processor 101 in order to request reauthentication.

If it is determined that the wireless mobile station 1 is within the service area of the wireless fixed station 2 at OPERATION S108 (NO at S108) or if it is determined that the restriction condition regarding time is not satisfied at OPERATION S109 (NO at S109), the wireless mobile station 1 determines whether the handover processor 106 has performed a handover process, i.e., whether the communication-partner wireless fixed station 2 has been changed (S111).

If it is determined that the communication-partner wireless fixed station 2 has been changed at OPERATION S111 (YES at S111), the counter 108 of the wireless mobile station 1 increments the value (e.g. the number of times of handover processing) by 1 (S112). The reauthentication determiner 109 then determines whether the value counted by the counter 108 satisfies a given restriction condition (S113).

More specifically, the wireless mobile station 1 determines whether a given restriction condition that the value counted by the counter 108 has reached a given value is satisfied at OPERATION S113.

If it is determined that the restriction condition regarding the counted value is satisfied at OPERATION S113 (YES at S113), i.e., if the given restriction condition that the value counted by the counter 108 has reached the given value is satisfied, the process proceeds to OPERATION S110. At OPERATION S110, the wireless mobile station 1 performs an execution restricting process. The process then returns to OPERATION S101. Operations starting from OPERATION S101 are repeated.

If it is determined that the communication-partner wireless fixed station 2 has not been changed at OPERATION S111 (NO at S111) or if it is determined that the restriction condition regarding the counted value is not satisfied at OPERATION S113 (NO at S113), the process returns to OPERATION S107. The wireless mobile station 1 then repeats operations starting from OPERATION S107.

In this manner, the wireless mobile station 1 requests reauthentication in response to a change in an access state indicating a status of communication with the wireless fixed station 2.

More specifically, the wireless mobile station 1 requests reauthentication after given time has passed since the wireless mobile station 1 was located in an out-of-service area of the wireless fixed station 2.

When the wireless mobile station 1 is located in an out-of-service area of one wireless fixed station 2 but in a service area of another wireless fixed station 2, i.e., when a handover process is performed, the wireless mobile station 1 is able not to request reauthentication. However, if the number of times of the handover processing reaches a given value, the wireless mobile station 1 requests the reauthentication.

When the wireless mobile station 1 temporarily enters a service area of a specific wireless fixed station 2 and then is located in the out-of-service area of the wireless fixed station 2, the wireless mobile station 1 may be treated as it is located in the out-of-service area even if the wireless mobile station 1 is located in a service area of another wireless fixed station 2 through handover.

Furthermore, the wireless mobile station 1 is able not to count a handover when the wireless mobile station 1 enters a service area of a specific wireless fixed station 2. The wireless mobile station 1 may increment the value of handover by more than 1 (e.g. 2) in response to a change to the specific wireless fixed station 2.

A plurality of restriction conditions may be set so that determination is performed in accordance with a communication network, a communication format, a communication rule, or a communication medium.

For example, if data communication is selected as the communication medium, an execution restricting process may be performed if a communication unavailable state continues for a short period. When a voice call, namely, telephone communication, is selected as the communication medium, execution restricting processing may be not performed. In this manner, various settings can be made in consideration for a balance between convenience and security.

The restriction condition corresponding to a wireless fixed station 2 may be acquired from the wireless fixed station 2 and set.

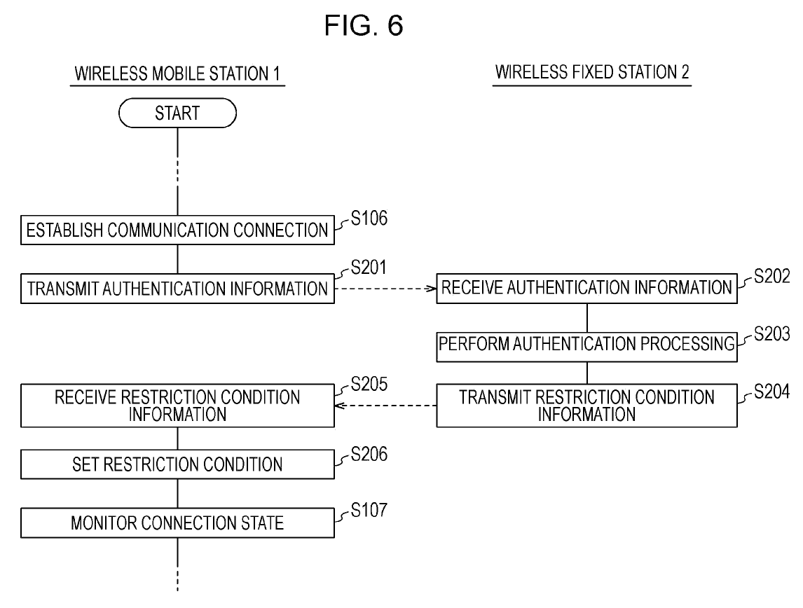

FIG. 6 illustrates an example of a process performed by the wireless mobile station 1 and the wireless fixed station 2.

The wireless mobile station 1 executes the process of OPERATIONs S101-S106 illustrated in FIG. 5 to establish a connection to a wireless LAN.

The communicator 12 of the wireless mobile station 1 transmits information indicating features of fingerprints scanned by the authenticator 18 and authentication information, such as identification information of the wireless mobile station 1, to the wireless fixed station 2 via the wireless LAN (S201).

The communication processor 200 of the wireless fixed station 2 receives the authentication information (S202). The wireless fixed station 2 causes the authentication apparatus 3 to execute an authentication process based on the received authentication information (S203).

In the authentication process (S203), the wireless fixed station 2 transmits the authentication information to the authentication apparatus 3. The authentication apparatus 3 compares the received authentication information with authentication information stored in the authentication BD 301a, thereby checking validity of the received authentication information. The authentication apparatus 3 then transmits the result to the wireless fixed station 2.

If the authentication processing has succeeded, the communication processor 200 of the wireless fixed station 2 transmits restriction condition information, which indicates a given restriction condition and is provided from the restriction information provider 201, to the wireless mobile station 1 via the wireless LAN (S204).

If the authentication process has failed, the wireless fixed station 2 executes processing, such as processing for prohibiting access from the wireless mobile station 1, for example.

The communicator 12 of the wireless mobile station 1 receives the restriction condition information (S205). The reauthentication determiner 109 sets the restriction condition indicated by the received restriction condition information (S206).

The wireless mobile station 1 then executes a process starting from OPERATION S107 illustrated in FIG. 5.

The wireless fixed station 2 may attach the restriction condition information to a signal, such as a beacon, to be transmitted to the wireless mobile station 1 that enters a service area of the wireless fixed station 2, for example.

By allowing a dynamic change of the restriction condition in this manner, a setting of the restriction condition can be changed in accordance with service areas.

For example, in a conference room where highly confidential information is handled, a setting for immediately requesting reauthentication once the wireless mobile station 1 is located in an out-of-service area may be made.

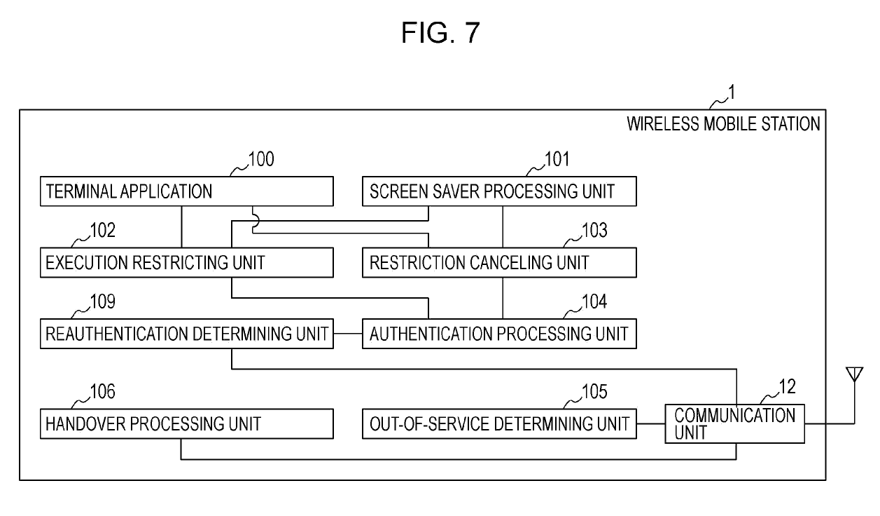

FIG. 7 illustrates an example of a functional configuration of the wireless mobile station 1.

A controller 10 executes a computer program PRG1 according to the present invention stored in a storage 11, whereby the wireless mobile station 1 functions as a terminal application 100, a screen saver processor 101, an execution restrictor 102, a restriction canceller 103, an authentication processor 104, an out-of-service determiner 105, a handover processor 106, and a reauthentication determiner 109.

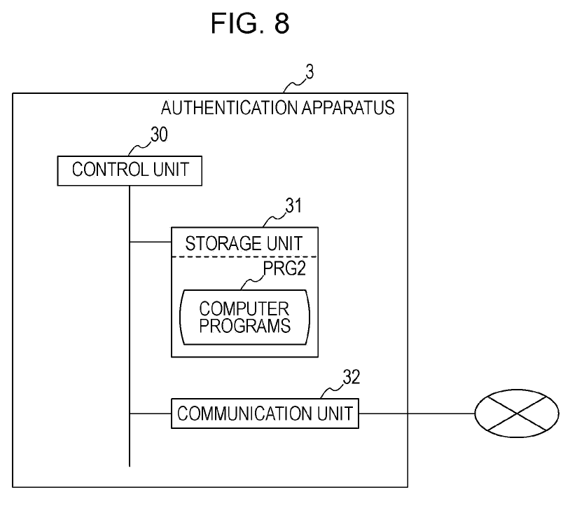

FIG. 8 illustrates an example of a hardware configuration of the authentication apparatus 3.

The authentication apparatus 3 includes a controller 30, a storage 31 that stores various control programs, such as a computer program PRG2, and various kinds of data, and a communicator 32.

The authentication apparatus 3 illustrated in FIG. 8 is realized by switching equipment for performing access control of a plurality of wireless fixed stations 2.

Functions of the communication apparatus may be implemented in the switching equipment. Another apparatus connected to the switching equipment may be used as an authentication apparatus.

In addition, the functions of the communication apparatus may be implemented in the wireless fixed station 2.

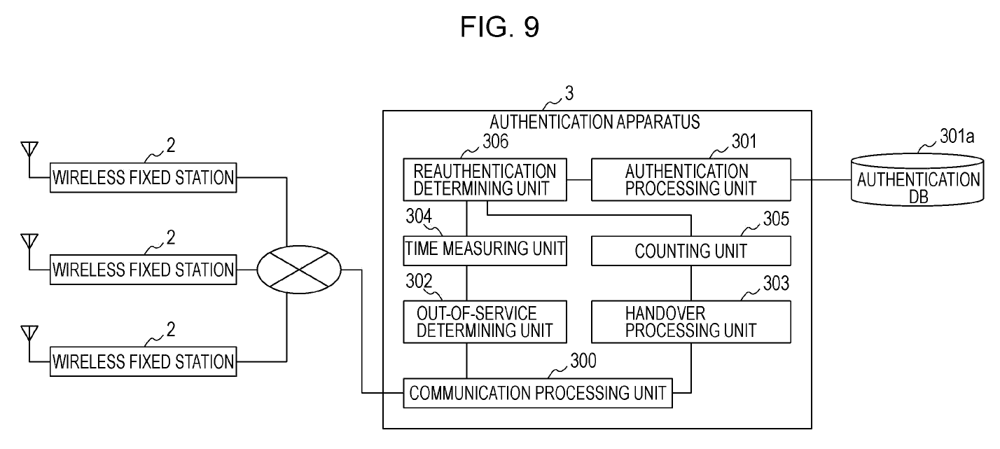

FIG. 9 illustrates an example of a functional configuration of the authentication apparatus 3.

The controller 30 executes the computer program PRG2 stored in the storage 31, whereby the authentication apparatus 3 functions as a communication processor 300, an authentication processor 301 connected to an authentication database (DB) 301a, an out-of-service determiner 302, a handover processor 303, a time measurer 304, a counter 305, and a reauthentication determiner 306.

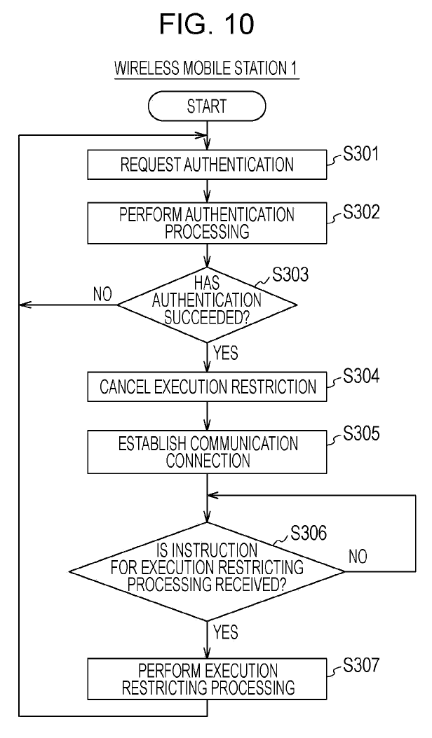

FIG. 10 illustrates an example of a process performed by the wireless mobile station 1.

Under control of the authentication processor 104, the wireless mobile station 1 requests authentication with execution of the terminal application 100 being restricted by the execution restrictor 102 (S301). The authentication processor 104 and the authenticator 18 operate in cooperation to an execute authentication process (S302). The authentication processor 104 determines whether the authentication has succeeded (S303).

If it is determined that the authentication has succeeded at OPERATION S303 (YES at S303), the restriction canceller 103 of the wireless mobile station 1 cancels restriction of execution of the terminal application 100 (S304).

If it is determined that the authentication has failed at OPERATION S303 (NO at S303), the process returns to OPERATION S301. The wireless mobile station 1 repeats operations starting from OPERATION S301.

After canceling the restriction of execution of the terminal application 100 at OPERATION S304, the communicator 12 of the wireless mobile station 1 establishes a connection to a wireless LAN (S305). The reauthentication determiner 109 determines whether an instruction for execution a restricting process that requests reauthentication is received from the authentication apparatus 3 through the wireless fixed station 2 (S306).

If it is determined that the instruction for the execution restricting processing is received at OPERATION S306 (YES at S306), the wireless mobile station 1 performs an execution restricting process (S307). The process then returns to OPERATION S301. The operations starting from OPERATION S301 are then repeated.

The execution restricting process performed at OPERATION S307 is processing for causing the execution restrictor 102 to restrict execution of the terminal application 100 and to start execution of the screen saver processor 101 in order to request reauthentication.

If it is determined that the instruction for the execution restricting process is not received at OPERATION S306 (NO at S306), the wireless mobile station 1 repeatedly performs the determination at OPERATION S306.

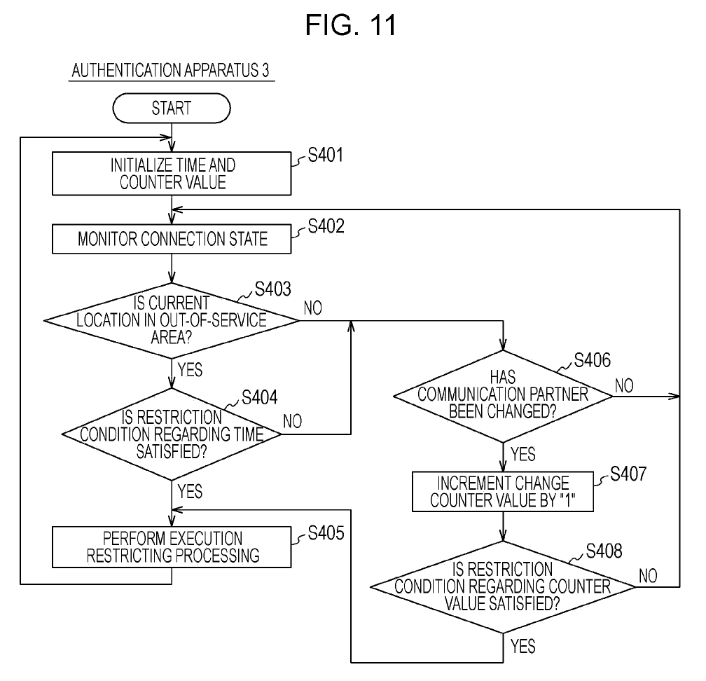

FIG. 11 illustrates an example of a process performed by the authentication apparatus 3.

When the wireless mobile station 1 establishes a connection to a wireless LAN and accesses one of the wireless fixed stations 2 for which the authentication apparatus 3 performs access control, the authentication apparatus 3 initializes time measured by the time measurer 304, assigned to the accessing wireless mobile station 1, and a value counted by the counter 305 (S401) to start monitoring the connection state (S402).

The out-of-service determiner 302 of the authentication apparatus 3 determines whether the monitoring-target wireless mobile station 1 is in an out-of-service area (S403).

If it is determined that the wireless mobile station 1 is in the out-of-service area and is difficult to utilize wireless communication at OPERATION S403 (YES at S403), the reauthentication determiner 306 of the authentication apparatus 3 determines whether the time, measured by the time measurer 304, that has elapsed since the wireless communication became difficult satisfies a given restriction condition (S404).

More specifically, at OPERATION S404, the authentication apparatus 3 determines whether a restriction condition that wireless communication with the wireless mobile station 1 is continuously difficult until the time measured by the time measurer 304 reaches a given value is satisfied.

If it is determined that the restriction condition regarding time is satisfied at OPERATION S404 (YES at S404), i.e., if it is determined that given time has passed since the wireless mobile station 1 is located in the out-of-service area, the authentication apparatus 3 executes execution restricting process (S405). The process then returns to OPERATION S401. The operations starting from S401 are then repeated.

The execution restricting process executed at OPERATION S405 is processing for transmitting an instruction for the execution restricting process to the wireless mobile station 1 in order to request reauthentication.

When the out-of-service area used here indicates an out-of-service area of a specific wireless fixed station 2, the instruction for the execution restricting process is transmitted through another communicatable wireless fixed station 2.

However, when the out-of-service area indicates out-of-service areas of all of the wireless fixed stations 2, the instruction for the execution restricting process is transmitted upon the wireless mobile station 1 entering a service area.

If it is determined that the wireless mobile station 1 is located in the service area at OPERATION S403 (NO at S403) or if it is determined that the restriction condition regarding time is not satisfied at OPERATION S404 (NO at S404), the authentication apparatus 3 determines whether the handover processor 303 has performed a handover process, i.e., whether the wireless mobile station 1 has changed the communication-partner wireless fixed station 2 (S406).

If it is determined that the communication-partner wireless fixed station 2 has been changed at OPERATION S406 (YES at S406), the authentication apparatus 3 increments the value counted by the counter 305 by 1 (S407). The reauthentication determiner 306 determines whether the value counted by the counter 305 satisfies a given restriction condition (S408).

More specifically, at OPERATION S408, the authentication apparatus 3 determines whether the given restriction condition that the value counted by the counter 305 has reached a given value is satisfied.

If it is determined that the restriction condition regarding the counted value is satisfied at OPERATION S408 (YES at S408), i.e., if the previously set restriction condition that the value counted by the counter 305 has reached a given value is satisfied, the process proceeds to OPERATION S405. At OPERATION S405, the authentication apparatus 3 executes the execution restricting process. The process then returns to OPERATION S401. The operations starting from S401 are then repeated.

If it is determined that the communication-partner wireless fixed station 2 has not been changed at OPERATION S406 (NO at S406) or if it is determined that the restriction condition regarding the counted value is not satisfied at OPERATION S408 (NO at S408), the process returns to OPERATION S402. The authentication apparatus 3 repeats the process at the operations starting from S402.

The embodiment can be applied to a communication apparatus connected to various wireless communication networks, such as a mobile phone network.

According to the aspect of the embodiments described above, the authentication is not required until given time that has elapsed since the wireless communication with the wireless station became difficult. Accordingly, a decrease in convenience can be prevented while maintaining the security.

According to the aspect of the embodiments described above, authentication is not required until the number of times that the wireless station has been changed reaches a given value. Accordingly, a decrease in convenience can be prevented while maintaining security.

According to the aspect of the embodiments described above, when communication with a wireless station, such as an access point of an in-house wireless LAN, is available, authentication is not requested. After given time has elapsed since the wireless communication with the wireless station became difficult, authentication is requested. Accordingly, it is possible to advantageously increase security by preventing the communication apparatus from being invalidly used after being taken to a place where communication with the wireless station is difficult. Additionally, since authentication is not required when the communication apparatus is continuously located at a place where communication with the wireless station is available, an in-coming call for the communication apparatus used, for example, in a company can be answered immediately. Accordingly, a decrease in convenience can be advantageously prevented. Furthermore, when wireless communication with the wireless station becomes difficult, authentication is not requested immediately but a given grace period is set. Accordingly, when reception of a radio wave temporarily becomes difficult because the communication apparatus is behind something while the communication apparatus is being carried in a room, authentication is not requested. Accordingly, a decrease in convenience can be advantageously prevented.

According to the aspect of the embodiments described above, when a plurality of wireless stations, such as wireless LAN access points, are provided in a company, authentication is requested if the number of times that the handover process for changing the communication-partner wireless station has been performed is equal to or greater than a given value. Accordingly, it is possible to advantageously increase security by preventing the communication apparatus from invalidly being taken to a remote place and being used. Since authentication is not requested as long as the number of times that the handover process has occurred in response to movement of a person carrying the communication apparatus is equal to or smaller than the given value, a decrease in convenience can be advantageously prevented.

The above-described embodiments are only some of infinite embodiments of the present invention. The hardware and software configurations can be designed appropriately.

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A communication apparatus comprising:
an executor configured to execute a given process;
a restrictor configured to restrict the executor from executing the given process;
an authenticator configured to perform authentication;
a canceller configured to cancel the restriction applied by the restrictor if the authentication by the authenticator has succeeded;
a communicator capable of wirelessly communicating with a wireless station; and
a time measurer configured to measure time that has elapsed since wireless communication with the wireless station became difficult,
wherein, if a previously set restriction condition is continuously satisfied until the time measured by the time measurer reaches a given value, the restrictor restricts execution of the given process, and
wherein the restriction condition pertains to continuance of a state where the wireless communication with the wireless station is difficult.

2. A communication apparatus comprising:
an executor configured to execute a given process;
a restrictor configured to restrict the executor from executing the given process;
an authenticator configured to perform authentication;
a canceller configured to cancel the restriction applied by the restrictor if the authentication by the authenticator has succeeded;
a communicator capable of wirelessly communicating with any one of a plurality of wireless stations; and
a counter configured to count the number of times that a communication-partner wireless station has been changed,
wherein, if the value counted by the counter satisfies a previously set restriction condition, the restrictor restricts execution of the given process, and
wherein the restriction condition is that the counted value reaches a given value.

3. The apparatus according to claim 1, further comprising:
a setter configured to set the restriction condition on the basis of information acquired from the wireless station.

4. A communication apparatus comprising:
a communicator capable of wirelessly communicating with a wireless mobile station that executes a given process;
an authenticator configured to request the wireless mobile station to perform an authentication process for canceling restriction of execution of the given process; and
a time measurer configured to measure time that has elapsed since wireless communication with the wireless mobile station became difficult,
wherein, if a previously set restriction condition is continuously satisfied until the time measured by the time measurer reaches a given value, the authenticator requests the authentication process again, and
wherein the restriction condition pertains to continuance of a state where the wireless communication with the wireless mobile station is difficult.

5. The apparatus according to claim 4, wherein the communicator communicates with the wireless mobile station through a wireless fixed station.

6. A communication apparatus comprising:
a communicator configured to communicate with a plurality of wireless fixed stations capable of wirelessly communicating with a wireless mobile station that executes a given process;
an authenticator configured to request the wireless mobile station to perform an authentication process for canceling restriction of execution of the given process; and
a counter configured to count the number of times that the wireless mobile station has changed the communication-partner wireless fixed station,
wherein, if the value counted by the counter satisfies a previously set restriction condition, the authenticator requests the authentication process again, and
wherein the restriction condition is that the counted value reaches a given value.

7. A computer-readable medium comprising a computer-executable instructions that cause a communication apparatus to execute:
requesting an authentication process for canceling restriction of execution of a given process;
measuring time that has elapsed since wireless communication with a wireless station became difficult; and
requesting the authentication process again if a previously set restriction condition is continuously satisfied until the measured time reaches a given value,
wherein the restriction condition pertains to continuance of a state where the wireless communication with the wireless station is difficult.

8. The apparatus according to claim 2, further comprising:
a setter configured to set the restriction condition on the basis of information acquired from the wireless station.
